(19) United States
(12) Patent Application Publication
(10) Pub. No.: US 2024/0189828 A1
(43) Pub. Date: Jun. 13, 2024

(54) RECYCLING OF LAMINATED GLASS

(71) Applicant: Andela Tool & Machine, Inc., Richfield Springs, NY (US)

(72) Inventors: Cynthia A. Andela, Richfield Springs, NY (US); David Spencer, Little Falls, NY (US); Jeffrey James Birt, Oriskany, NY (US)

(73) Assignee: Andela Tool & Mahcine, Inc., Richfield Springs, NY (US)

(21) Appl. No.: 18/063,310

(22) Filed: Dec. 8, 2022

(51) Int. Cl. B02C 13/04; B02C 13/13; B02C 13/28

(52) U.S. Cl. CPC B02C 13/04; B02C 13/13; B02C 13/28; B02C 2013/28663

(57) ABSTRACT

A machine for comminuting laminated glass members, such as automotive windshields and architectural glass, comprises infeed rollers feeding the member over a breaker bar, where an impactor assembly breaks the glass into small fragments and the plastic disposed between layers of the glass member into larger fragments, so that a size-based separation may be employed. The speed of the infeed rollers is controlled responsive to the thickness of the glass member.

### FIELD OF THE INVENTION

This invention relates generally to glass recycling machinery. In particular, the present invention is concerned with an apparatus for recycling laminated glass, such as automotive windshield glass and certain architectural glass. Laminated glass employed for these purposes comprises two (or more) sheets of glass laminated to either side of one or more plastic sheet(s). Recycling of such laminated glass items requires, in essence, that the glass be comminuted into small pieces while the plastic liner remains in larger pieces, enabling a size-based separation step, so that the glass and plastic can be separately recycled.

### BACKGROUND OF THE INVENTION

This application is directed to certain improvements in machinery for recycling laminated glass as described in U.S. Pat. No. 5,984,216 (“the '216 patent”). As such, much of the below description, and FIGS. 1-5, are taken from the '216 patent.

One of the improvements made by the present application with respect to the '216 patent lies in the broadening of its scope to laminated architectural glass. Laminated architectural glass resembles automotive windshield glass in that it comprises two sheets of glass adhesively bonded to either side of a sheet of plastic, the idea in each case being that a broken glass item will not shatter when broken but will remain in one piece, for safety reasons. However, laminated architectural glass is typically thicker than automotive windshield glass, and requires somewhat different processing techniques—in general, more power is required to comminute the heavier architectural glass, which can be provided by slower operation.

Therefore, one improvement according to the present invention is to sense the presence of architectural glass as opposed to windshield glass, and to provide a circuit that slows the operation of the glass recycling machine when appropriate.

Other improvements made by the present invention with respect to the '216 patent, without limitation, are directed to the infeed mechanism, the breaker bar support assembly, and the disposition of the impactors around their drive shaft.

In the following, taken largely from the '216 patent, reference to automotive windshield glass is to be understood to include laminated architectural glass. Likewise, reference to an automotive windshield shop or the like should be understood to include a business that recycles architectural glass.

In order to efficiently recycle or dispose of an automotive windshield, it is desirable to comminute the glass. Numerous machines have been developed specifically for comminuting empty glass containers. These machines typically include an inlet opening through which the glass containers are inserted and an outlet opening through which the broken glass fragments and glass dust are ejected. To accomplish the breaking of the glass, these machines usually employ either a crushing apparatus or a hammermill form of breaker apparatus.

For several reasons, existing glass comminuting machines are not well adapted for the recycling or disposal of automotive windshields. First, such devices are extremely large and are typically only found at large recycling plants. It is not common for an auto glass shop to have ready access to such a recycling machine. Second, the inlet opening through which the glass enters the comminuting machine is typically of a dimension which requires that the windshield be broken into smaller pieces prior to its insertion into the opening.

Third, an automotive windshield is comprised of two layers of glass and a plastic liner bonded securely between them. This construction requires that the glass must first be freed from the plastic liner material before it can be recycled.

A fourth problem associated with existing devices employed for the recycling of automotive windshields is that machines that employ a crusher-type apparatus are susceptible to jamming when plastic is inserted into the machine's inlet. The presence of the plastic liner sandwiched between the two layers of glass thus prevents the use of this type of machine.

Finally, after the glass has been freed from the surface of the plastic liner, the two materials are commingled and must be separated for recovery and recycling.

It is therefore desirable to provide an apparatus that can accommodate a glass sheet of the dimensions of an automotive windshield, and thereby eliminate the need to fragment the sheet prior to beginning the recycling or disposal process.

It is also desirable to provide an apparatus that can strip the two layers of glass off of the inner plastic liner material and then separate the two substances for recovery.

### SUMMARY OF THE INVENTION

It is a feature of the invention of the '216 patent to provide a compact automotive windshield recycling machine that can be used on site, thereby eliminating the need to transport the windshield to an independent recycling plant. Due to its small, compact size, the recycling machine of the '216 patent can be placed in a typical automotive or glass repair shop without taking up a large amount of valuable workspace. The compact, space-saving feature will also be of value to a central recycling plant.

It is a second feature of the invention of the '216 patent to provide a glass recycling machine having an inlet opening that will accommodate the full width of a typical automotive windshield, thereby eliminating the need to fragment the sheet of glass prior to utilizing the machine. The sheet of glass is drawn into the machine by dual feed rollers that each have a shaft on both ends. The shafts extend through openings in the housing side plates and turn in bearings each mounted on an offset. The lower offsets are fixedly mounted to the housing side plates while the upper offsets are slidably attached to the housing side plates, allowing the upper roller to be lifted upwardly to accommodate the thickness of the glass windshield.

It is another feature of the invention of the '216 patent to include a stationary breaker bar and an impactor assembly comprising an adjustable rotating impactor shaft driven for rotation and having a plurality of flexible impactors attached thereto. As the glass sheet is fed into the interior of the machine via the feed rollers, it passes over the stationary breaker bar and into the line of impact of the rotating flexible impactors. The combination of the stationary breaker bar and the rotating impactors acts to strip the glass from both sides of the inner plastic liner. The glass is comminuted into particles the size of fine gravel and sand while the plastic liner remains in much larger fragments.

It is a further feature of the invention of the '216 patent to provide a shaker screen below the rotating impactor shaft. The much smaller-sized glass particles pass through the shaker screen into a glass recovery container below the unit. The larger plastic fragments remain on the shaker screen and are carried out of the unit and into a separate recovery container. Alternatively, the glass and plastic may be separated from one another in a different machine performing size-based separation.

### BRIEF DESCRIPTION OF THE DRAWINGS

These and other advantages of the present invention will become more readily apparent upon reading the following detailed description and upon reference to the drawings in which

FIG. 1 is an isometric view of a preferred embodiment of the stripper/recycling machine of the invention of the '216 patent.

FIG. 2 is an isometric view of a preferred embodiment of the stripper/recycling machine of the invention of the '216 patent, taken from the opposite side with respect to FIG. 1.

FIG. 3 is a front view, depicting the belt drive mechanism of a preferred embodiment of the stripper/recycling machine of the invention of the '216 patent.

FIG. 4 is a first side view of a preferred embodiment of the stripper/recycling machine of the invention of the '216 patent.

FIG. 5 is a second side view of a preferred embodiment of the stripper/recycling machine of the invention of the '216 patent.

FIG. 6 is a schematic diagram of a control algorithm for adjusting the infeed speed according to the present invention.

FIG. 7 is an exploded view of a breaker bar assembly employed in commercial embodiments of the invention of the '216 patent, but not discussed therein.

FIG. 8 is a perspective view of a portion of the apparatus, showing the infeed rollers, breaker bar, and impactors.

FIG. 9 is a side view of a portion of the apparatus, again showing the infeed rollers, breaker bar, and impactors.

FIG. 10 is a perspective view of the shaft driving the impactors, illustrating a preferred spiral pattern of the disposition of the impactors.

FIG. 11 is a detail view showing a preferred embodiment of the breaker bar support components, enabling ready removal thereof.

FIG. 12 is an isometric view of an improved infeed mechanism according to the present invention.

### DETAILED DESCRIPTION OF THE DRAWINGS

Referring now specifically to the drawings, there is illustrated an automotive windshield stripper/recycling machine, generally designated as 11, wherein like reference numerals refer to like elements throughout the drawings.

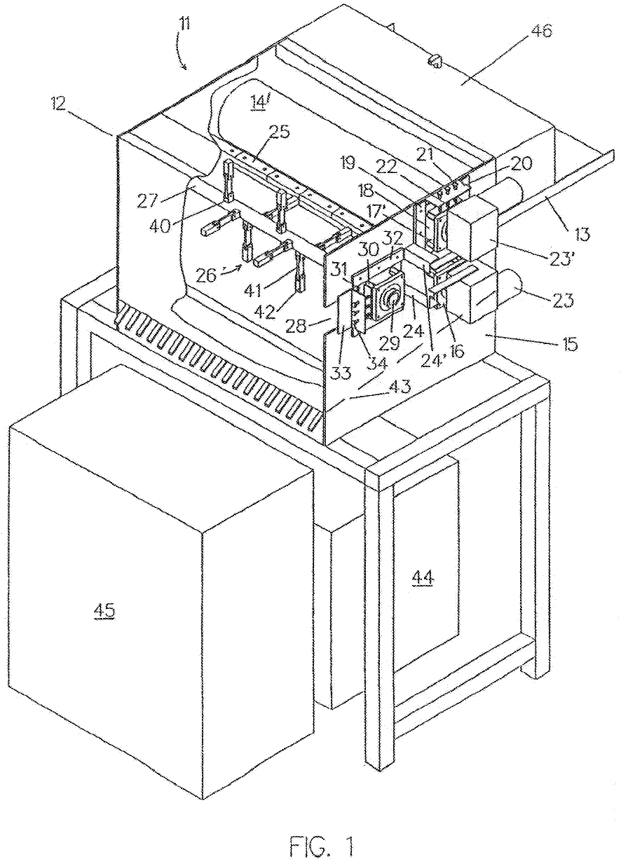

As can be seen in FIG. 1, the windshield stripper 11 comprises a box-like housing 12 having a rear mounted infeed table 13. A windshield (not shown in FIG. 1 but illustrated elsewhere) placed onto infeed table 13 is drawn into the housing 12 by means of two parallel driven horizontal infeed rollers 14, 14′ (the lower roller 14 not being visible in FIG. 1, but illustrated elsewhere). Both infeed rollers 14, 14′ extend the full width of the housing 12 and have a shaft (not shown) attached at each end. Each shaft extends through an opening in one of the housing side plates 15 and into bearings 16 that are mounted on offsets 17, 17′. Seals (not shown) are utilized to isolate each of the bearings 16 from abrasive residual glass dust. The lower offsets 17 are fixedly mounted on the outer surface of each of the opposing housing side plates 15. The upper offsets 17′ are affixed to mounting plates 18 that are held against the housing side plate 15 by means of two retaining strips 19 that are securely attached to the housing side plate 15. Thus, the mounting plates 18 can slide freely between housing side plate 15 and retaining strips 19. Mounted on each of the housing side plates 15 proximate the slidable mounting plate 18 is a bracket 20 having screws 21 passing therethrough. Mounted on screws 21 are heavy duty compression springs 22. Compression springs 22 apply pressure to the offsets 17′ such that infeed rollers 14, 14′ are compressed together. As a windshield is fed into the unit 11, compression springs 22 allow mounting plates 18 to slide upward between the housing side plate 15 and retaining strips 19 and thereby raise upper infeed roller 14′ to accommodate the thickness of the windshield. Compression springs 22 exert enough pressure so that infeed rollers 14, 14′ securely hold the windshield and feed it into the unit 11 without slippage.

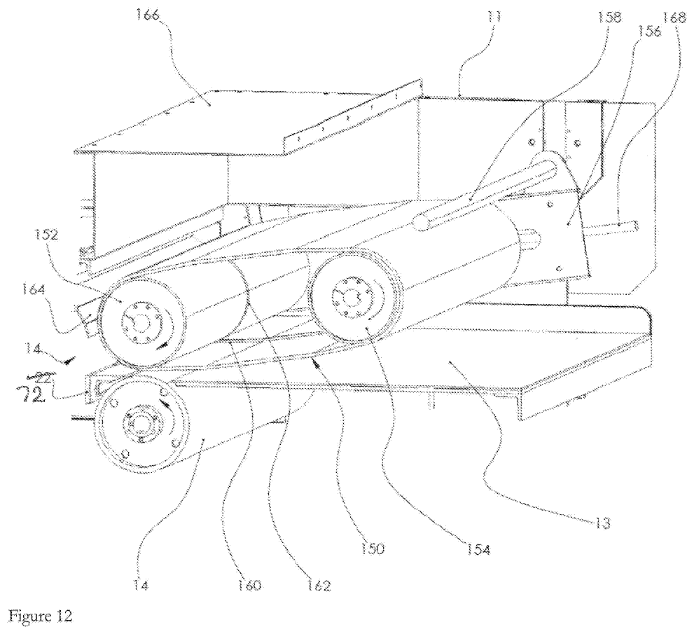

As indicated above, improvements in the infeed mechanism provided according to the present invention are discussed below in connection with FIG. 12.

Referring to FIG. 1, each of infeed rollers 14, 14′ is driven directly by a gear reducer and motor assembly 23, 23′. Gear reducer/motor assemblies 23, 23′ are mounted on one end of each feed roller shaft. Anti-rotation devices 24, 24′ are attached to each gear reducer to prevent rotation movement of the gear reducer/motor assembly 23, 23′.

As shown in FIG. 1, after the windshield enters the unit 11 through infeed rollers 14, 14′, it passes over stationary breaker bar 25 which extends the full width of the housing 12. Breaker bar 25 is formed of a hardened abrasion resistant material such as steel. As the windshield passes over the edge of breaker bar 25, it comes into the path of a plurality of rotating flexible impactors 26, comminuting the glass into small particles. The force of the rotating impactors 26 acts to pull the windshield down over breaker bar 25 and to strip the glass off the inner plastic liner. It is the combination of the stationary breaker bar 25 on the underside and the rotating flexible impactors 26 on the topside of the windshield which acts to strip the glass particles off both surfaces of the plastic liner. The glass is comminuted into particles the size of fine gravel and sand while the plastic liner remains in much larger fragments. A size-based separation step can then be employed to separate the glass particles from the plastic for recycling.

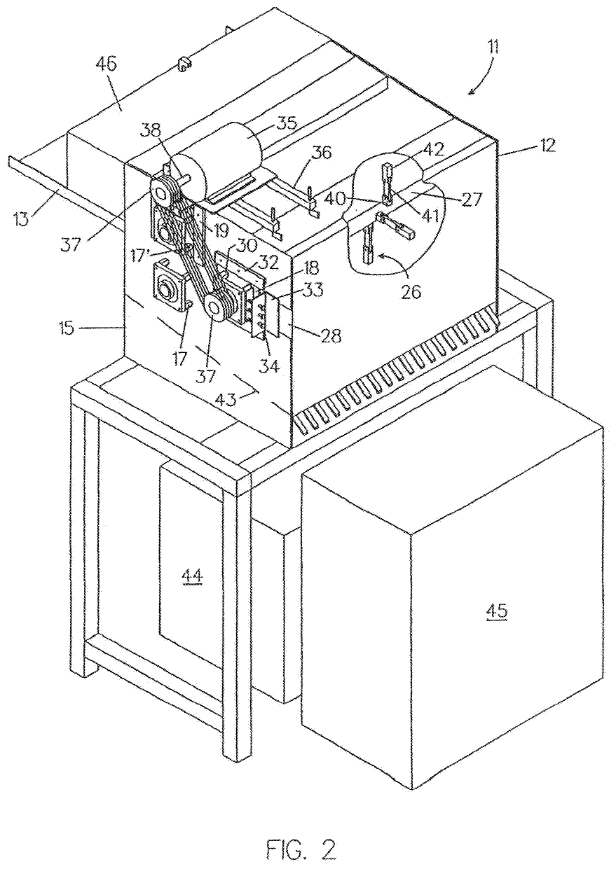

Referring to FIGS. 1 and 2, it is seen that flexible impactors 26 are mounted on a rotating impactor shaft 27 that extends the full width of housing 12 and out through openings 28 in each housing side plate 15. Rotating impactor shaft 27 turns in bearings 29 mounted on offsets 30 that are mounted on mounting plates 31. Mounting plates 31 are held securely in place against housing side plate 15 by means of two retaining strips 32. Secured to each housing side plate 15, proximate impactor shaft offsets 30, is an adjustment device 33 which functions to move impactor shaft 27, and consequently, flexible impactors 26, closer to stationary breaker bar 25 as the flexible impactors 26 become shorter with wear over time. As shown, adjustment device 33 can be screws 34 abutting impactor shaft offsets 30. To employ adjustment device 33, the screws are loosened on retaining strips 32, thereby freeing mounting plate 31, and as screws 34 are engaged against offsets 30, mounting plates 31 are moved, and consequently, bearings 29, impactor shaft 27 and flexible impactors 26. After flexible impactors 26 have been properly repositioned, retaining strips 32 are then retightened to resecure mounting plate 31 to the housing side plate 15.

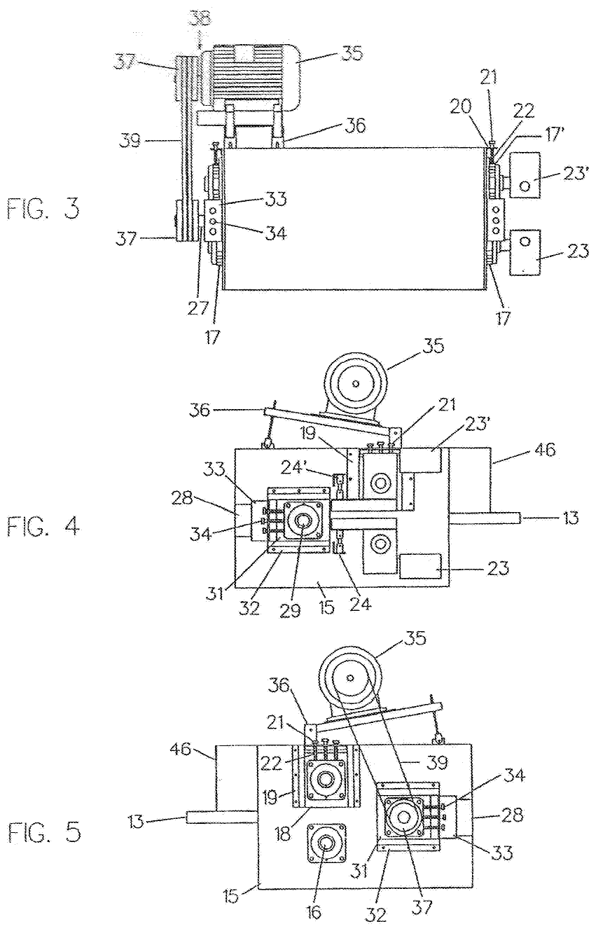

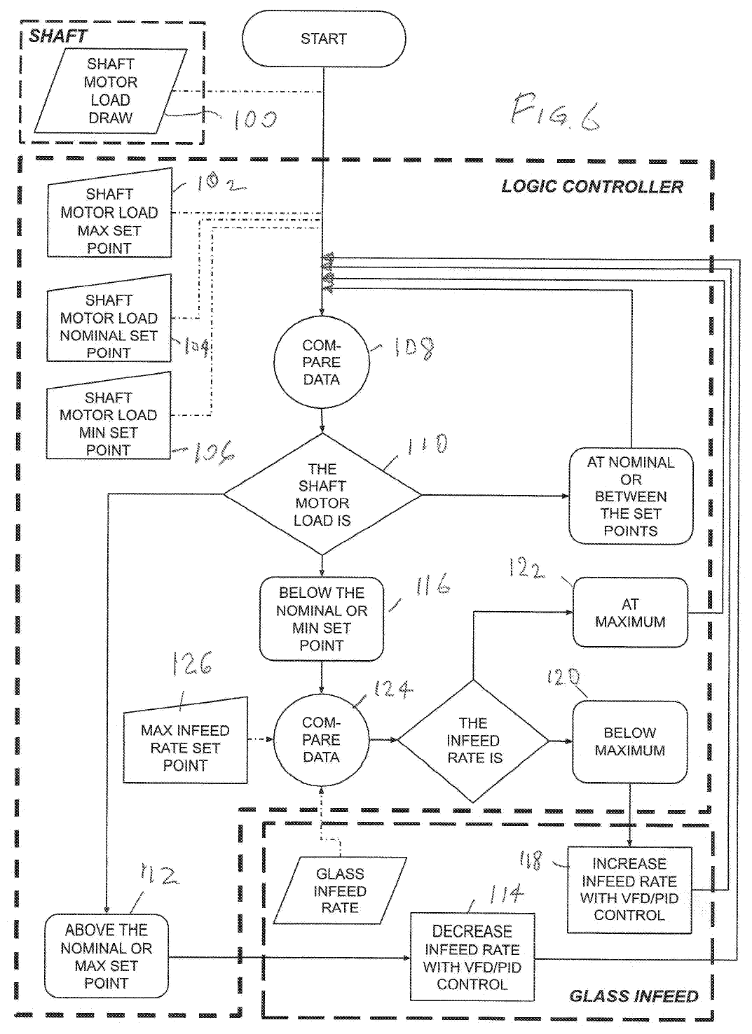

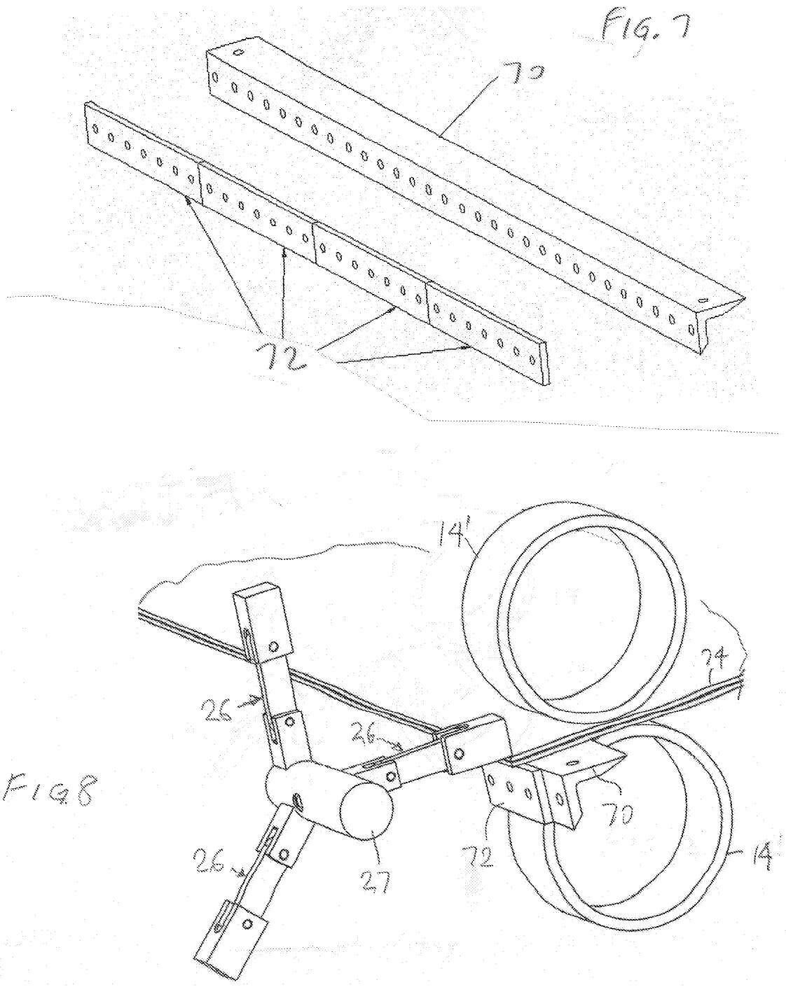

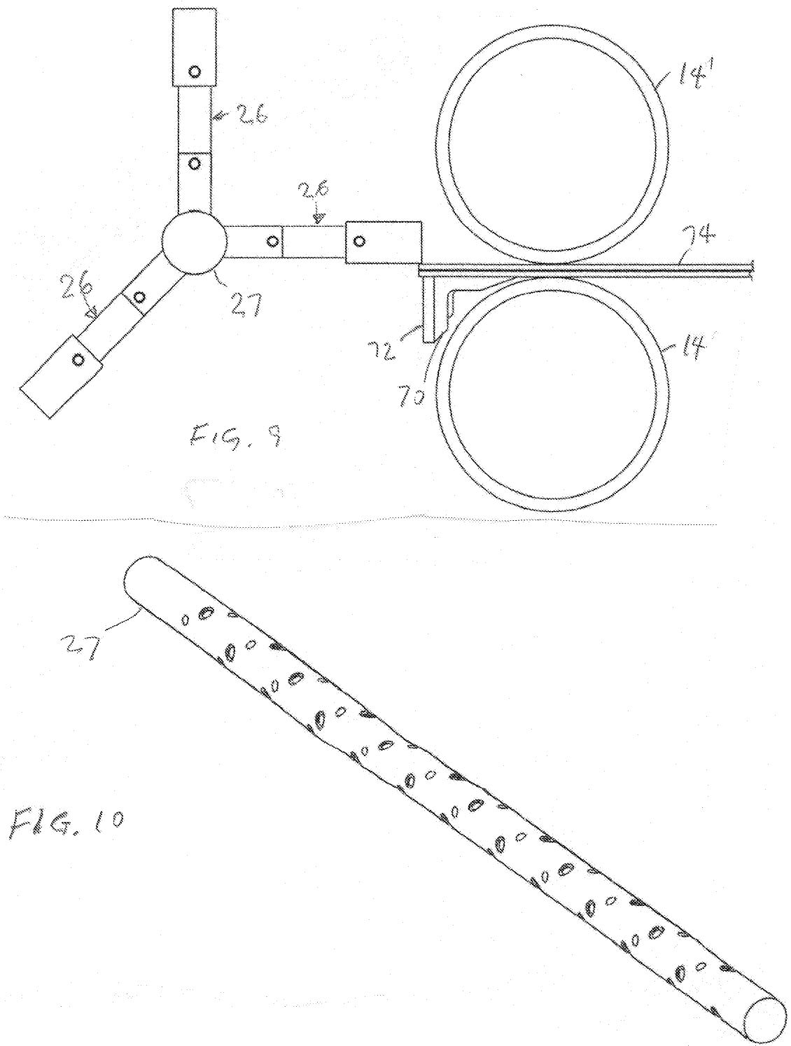

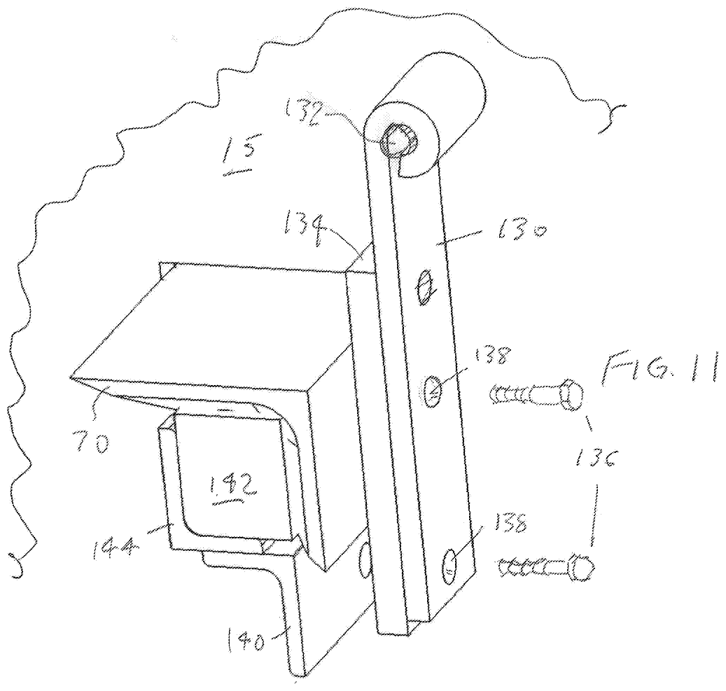

As seen in FIGS. 2, 4 and 5, opening 28 in housing side plate 15 extends forward to the front edge of housing plate 15. To remove impactor shaft 27 from the unit, as may be required for maintenance, adjustment device 33 is first removed and then retaining strips 32 are loosened, freeing mounting plates 31. Impactor shaft 27 can then be removed out through opening 28 and from the unit. The ease with which impactor shaft 27 can be removed greatly facilitates maintenance and replacement of flexible impactors 26.

As seen in FIGS. 2, 3 and 5, rotating impactor shaft 27 is driven by motor 35 (not shown in FIG. 1) which is secured to adjustable motor mount 36 on the top surface of housing 12. Power is transferred from motor 35 to impactor shaft 27 by means of a belt drive system. Bearings and sheaves 37 are mounted on motor drive shaft 38 and impactor shaft 27. Belts 39 encircle the two sheaves 37.

Referring to FIGS. 1 and 2, it is seen that flexible impactors 26 are each comprised of a stanchion 40, a link 41 and a hammer 42. To increase the flexibility of the impactors 26, stanchion 40 and hammer 42 are pivotally attached to opposite ends of link 41. The links 41 and hammers 42 are formed of hardened abrasion resistant steel or other hard abrasion resistant material. Preferably, flexible impactors 26 are securely mounted onto rotating impactor shaft 27 in a spiral pattern, although other balanced arrangements can be used. The hammers 42 may be designed for removal and replacement in opposed orientations, so that fresh sharp edges can be provided as the leading edges wear over time.

As shown in FIGS. 1 and 2, a preferred embodiment of the invention of the '216 patent includes a downwardly slanted shaker screen 43 that is located directly below the rotating flexible impactors 26. As the glass Is stripped from the inner plastic liner, it is hammered into particles the size of fine gravel and sand, while the plastic liner is broken into much larger fragments. The glass particles pass through shaker screen 43 into recovery container 44 located below housing 12. The plastic fragments remain on shaker screen 43 and slide down into a second recovery container 45.

As can be seen in FIGS. 1, 2, 4, and 5, infeed guard 46 is mounted on the rear of housing 12, over infeed table 13. Infeed guard 46 protects the operator from the rotating action of feed rollers 14 and from any glass which might pop off the windshield. As the windshield is impacted and pulverized, abrasive glass dust is created. A dust collection device or spraying a fine mist on the windshield as it is fed into the feed rollers can be employed to control this residual glass dust. Infeed guard 46 provides a point of attachment for a dust collection unit or a misting device.

According to the present invention, as described above, it was desired to broaden the scope of use of the device of the '216 patent to reach beyond automotive windshields and specifically to include laminated architectural glass. The latter is typically thicker than the former and is best processed at slower speeds. Therefore, it was desired to detect the thickness of the laminated glass member to be separated from the plastic central layer and slow the processing speed correspondingly.

FIG. 6 shows a flowchart of steps that may be carried out by a logic controller to perform this function. As noted, it was found that the impactor shaft 27 tends to slow down due to overload when thicker glass is presented for processing. Accordingly, it was desired to reduce the input speed under such circumstances. Therefore, at step 100 the motor load, that is, the current drawn by the motor 35 driving the impactor shaft 27, is sensed. Alternatively, but less preferably, the variation in the speed of motor 35 could be sensed to measure the load. Predetermined values for the maximum, nominal, and minimum motor current are stored at 102, 104, and 106 respectively. These are compared to the sensed motor current at steps 108 and 110. If the sensed motor current is above the nominal or maximum value, as noted at 112, the infeed rate is reduced at 114. Control is then returned to step 108, establishing a feedback loop. The input rate correction may involve variable-frequency drive (“VFD”) or proportional-integral-derivative (“PID”) control techniques, both well-known to those of skill in the art. If the motor current is below the nominal value, as determined at 116, the infeed speed may be increased, at indicated at 118, provided that the infeed speed is less than its maximum value, as determined at 120. If the infeed rate is at its maximum value, as determined at 122 by comparison to a predetermined value set at 126, it is not further increased. In each case, control is repeatedly returned to steps 108 and 124, establishing a feedback loop, such that comparison steps 108 and 124 are performed repeatedly.

More specifically, as heavier-gauge laminated glass is fed into the machine for separation of the glass from the plastic liner, the impactor shaft tends to slow due to the increased force required to break the glass. The typical AC motors used to power the impactor shaft are designed to run at constant RPM and therefore will draw more current in order to meet the increased load. This current increase is sensed and used to control the speed of the infeed rollers, so that the load on the impactor shaft and the current drawn are reduced to nominal levels.

It would also be within the scope of the invention to monitor the displacement of the upper infeed roller 14′ when a glass member is fed in for processing, and to control the infeed rollers' speed accordingly.

The '216 patent simply refers to the breaker bar 25 and does not go into detail. It was observed that over time in use the working upper corner of the breaker bar 25 became worn and rounded due to the many impacts of the impactors on the glass, and the consequent pounding of the glass against this corner of the breaker bar, reducing efficiency of operation. Therefore, over time in the commercialization of the invention of the '216 patent, the breaker bar was provided in the form of a breaker bar support beam 70 and a number of breaker bar edge members 72. See FIG. 7. As illustrated, the breaker bar edge members 72 are rectangular members in both longitudinal and cross-sectional directions. They are drilled at regular intervals along their centerlines so as to be secured to the breaker bar support beam 70 by screws (not shown) in any of four orientations. The screws are flat-headed and fit into countersinks or counterbores in the breaker bar edge members so as not to interfere with the movement of comminuted glass and plastic downwardly, nor with the passage of the impactors thereby. Similar countersinks or counterbores are provided on the rear surfaces of the breaker bar edge members. Accordingly, when the working upper corners of the breaker bar edge members 72 have become worn through use, they can be removed and rotated endwise or longitudinally, so that a total of four fresh corners is provided.

According to an aspect of the present invention, the breaker bar support beam 70 with the breaker bar edge members 72 attached can be removed from the machine 11 through a side wall to facilitate this operation. See FIG. 11. This shows, as indicated above, a detail view of the components allowing ready removal of the breaker bar assembly from one side of the overall machine, so as to allow convenient removal and replacement of the breaker bar edge members 72. These components include a pivoting hold-down bracket 130, which pivots on a pin 132 affixed to the outer side plate 15 of the machine 11. If desired, a vibration-dampening rubber pad 134 may be affixed to the hold-down bracket 130. Bolts 136 extend through bores 138 in hold-down bracket 130 and are threaded into corresponding threaded bores (not shown) in breaker bar support beam 70 and, in the embodiment depicted, a lower support bar 140. Lower support bar 140 is provided in this embodiment to support a second vibration-dampening rubber member 142, which is further supported by a second support bar 144. A generally similar structure is provided on the opposite side of the machine 11.

Lower support bar 140, vibration-dampening rubber member 142, and second support bar 144 are external to the wall 15 of the machine 11, while breaker bar support beam 70 runs entirely through the body of the machine 11.

Thus, in order to provide a fresh cutting edge by removal and realignment or replacement of the breaker bar edge members 72, bolts 136 are removed, and hold-down bracket 130 with vibration-dampening member 134 are pivoted counterclockwise in the view of FIG. 11. (Similar bolts are removed on the opposite side of machine 11.) This exposes an aperture in the side wall 15, allowing removal of the breaker bar support beam 70 with the breaker bar edge members 72 attached.

FIGS. 8 and 9 show the relationship between the breaker bar support beam 70, breaker bar edge members 72, infeed rollers 14, 14′ and impactors 26. It will be observed that the rear edge of the upper portion of the generally L-shaped breaker bar support beam 70 is contoured so as to closely conform to the cylindrical surface of the lower infeed roller 14, thus fully supporting the glass element 74 to be comminuted. The spacing of the lower edge of the breaker bar support beam 70 from the lower infeed roller 14 is slightly greater to ensure clearance for any glass particles. It is also within the scope of the invention to interpose hard rubber members between the breaker bar edge members 72 and the breaker bar support beam 70, to dampen vibration. Likewise, or alternatively, hard rubber pads may be interposed between the ends of the breaker bar support beam and its support on the body of the machine.

FIG. 10 shows a perspective view of the impactor shaft 27, illustrating bores drilled therethrough with countersinks for the heads of attachment bolts for mounting of impactors 26. As illustrated, these bores are disposed in a spiral pattern, preferably with adjacent bores at 135° to one another. In this way adjacent impactors 26 do not contact one another.

Thus, according to the invention, the breaking of the two glass members and the stripping of the glass fragments from the plastic interior sheet takes place in two stages, both of which can happen immediately upon striking or over the course of multiple strikes, depending on several material and bonding factors. Initially, the glass must be fractured, just as if it was in a car accident, separating the glass itself into small pieces. The action of the impactors striking the laminated glass member against the rigid breaker bar accomplishes this. Next, the small pieces of glass must be separated from the plastic. The glass pane is now much more flexible due to the breakdown of mechanical integrity. As the impactors 26 spin and strike the sheet, the small, individual bits of glass that may be clinging to the plastic are violently squeezed against the breaker bar and are stripped by shearing mechanical forces.

The gap between the impactors 26 and the breaker bar edge members 72 is important as follows:

The impactors 26 should not be too close to the breaker bar edge members 72 or the impactors 26 will wastefully strike the breaker bar edge members 72.

The impactors 26 must be close enough to the breaker bar edge members 72 to create the approximate preferred size of glass particle, usually about ⅛″, though obviously a variety of sizes result, including a certain amount of dust.

Too large a gap will result in more unstripped volume, reducing output and efficiency.

A thicker laminated architectural glass member may require a somewhat larger gap, but once the impactors 26 strike, the thickness of the plastic needs to fit in the gap so that the remaining attached glass fragments can be stripped from the plastic liner. Processing of thicker glass members mainly requires more power and/or slower feed speeds, as described above.

As the impactors 26 wear down, the gap increases, requiring that the rotating shaft 27 be adjusted closer to the breaker bar for optimal performance.

As mentioned above, FIG. 12 shows an improved infeed mechanism according to the present invention. The principal improvement is in the provision of an endless infeed drive belt driven over spaced rollers to provide increased friction between the infeed assembly and the glass member to be recycled.

Thus, as illustrated, an endless infeed belt 150 rides on rollers 152 and 154, where roller 152 corresponds approximately to roller 14′shown in other Figures. One of rollers 152 and 154 is driven by a motor (not shown). Rollers 152 and 154 are mounted on shafts journaled in bearings (not shown) mounted on opposed frame members 156 (only the distal member being shown) pivoting on a rod 158, such that the downstream roller 152 can be deflected upwardly against bias provided by springs (not shown) when a member of laminated glass to be comminuted is inserted therebetween. Belt tension is adjusted by way of threaded rods 168. Roller 152 with belt 150 thereover rests on top of bottom roller 14, which prevents belt 150 from coming into contact with infeed table 13.

The inner side of belt 150 may be formed to include a V-shaped wedge 160 fitting within correspondingly-shaped grooves 162 in rollers 152 and 154, to ensure the belt 150 stays in the correct position and does not slide off to one side or the other. Plural such wedges and grooves may be provided.

Protective baffles 164 and 166 may be provided to contain dust and glass fragments resulting from the comminution operation.

The embodiments disclosed herein have been discussed for the purpose of familiarizing the reader with the novel aspects of the invention. Although preferred embodiments of the invention have been shown, many changes, modifications and substitutions may be made by one of ordinary skill in the art without necessarily departing from the spirit and scope of the invention as described in the following claims.

What is claimed is:

1. A device for comminuting a laminated glass member comprising first and second glass sheets laminated on either side of a planar plastic liner, and separating the glass and plastic thereof, comprising:
a hollow housing having an inlet aperture formed therein;
a pair of infeed rollers mounted within said housing and juxtaposed to said inlet aperture and driven for rotation about horizontal axes, whereby a laminated glass member to be comminuted is fed into said aperture and drawn into said housing by said rollers;
a breaker bar fixed within said housing, said breaker bar defining a sharp horizontal edge parallel to the axes of said paired infeed rollers and disposed proximate said rollers, such that a laminated glass member fed between said rollers passes over said sharp edge of said breaker bar;
an impactor assembly comprising a shaft driven for rotation about an axis parallel to said sharp edge of said breaker bar, and a plurality of impactors mounted on said shaft, said impactor assembly being disposed within said housing such that as said shaft is rotated, distal ends of said impactors pass closely by said sharp edge of said breaker bar, and force an exposed edge portion of said laminated glass member downwardly over said sharp edge of said breaker bar, whereby said impactors comminute said upper and lower sheets thereof into relatively small fragments of glass, and break said plastic liner into relatively larger fragments; and
a size discrimination separator for separating said relatively small fragments of comminuted glass from relatively large fragments of the plastic of said liner; and
wherein the thickness of the laminated glass member to be comminuted is sensed and the speed of the infeed rollers varied responsive thereto, such that thicker members are processed at slower speeds than thinner members.

2. The device of claim 1, wherein the thickness of the member is sensed by sensing variation in the speed or current of a motor driving said impactor shaft with respect to a predetermined value.

3. The device of claim 1, wherein said size discrimination separator comprises a shaker screen mounted below said rotating impactor assembly.

4. The device of claim 1, further comprising:
an infeed table mounted to the exterior of said housing adjacent to said horizontally oriented feed rollers; and
an infeed guard mounted over said infeed table.

5. The device of claim 1, wherein at least a first of said paired infeed rollers is spring-biased toward the second thereof, whereby said rollers can part to admit a laminated glass member therebetween.

6. The device of claim 1, wherein said shaft of said impactor assembly is journaled on bearings mounted for convenient adjustment of the position of the axis of said impactor assembly with respect to said breaker bar, whereby the spacing of the distal ends of said impactors from said sharp edge of said breaker bar can be maintained at a desired distance.

7. The device of claim 1, wherein said impactors each comprise:
a stanchion attached to said impactor shaft;
a link pivotally attached to said stanchion; and
a hammer pivotally attached to said link.

8. The device of claim 7, wherein said links and said hammers are formed of a hardened abrasion-resistant material.

9. The device of claim 8, wherein said hardened abrasion-resistant material is abrasion-resistant steel.

10. The device of claim 1, wherein said breaker bar comprises a breaker bar support beam and a plurality of breaker bar edge members assembled thereto, said breaker bar edge members being symmetrical so as to be assembled to said breaker bar support beam in a plurality of orientations, whereby as said breaker bar edge members wear in use, the assembly can be removed and the breaker bar edge members removed and reassembled to the breaker bar support beam in differing orientations than previously, so as to present fresh cutting edges.

11. The device of claim 1, wherein a third infeed roller is provided, spaced from at least one of said infeed rollers, and wherein an endless belt is disposed over said third infeed roller and said at least one of said infeed rollers, such that said belt contacts a laminated glass member to be comminuted.

12. A device for comminuting glass layers of a laminated glass member and breaking a plastic liner thereof, and for separating glass and plastic fragments thus created, comprising:
a hollow housing;
a pair of horizontally oriented feed rollers each operatively attached to a drive motor;
a horizontal breaker bar fixedly attached within said housing, proximate said horizontally oriented feed rollers;
an impactor assembly within said housing, proximate said breaker bar, said impactor assembly comprising an impactor shaft mounted for rotation about a horizontal axis and a plurality of impactors mounted on said rotating impactor shaft;
a motor for rotating said impactor shaft;
wherein said impactor shaft is spaced from said breaker bar such that distal tips of said impactors closely approach a cutting edge of said breaker bar, forcing an exposed edge portion of said windshield downwardly over said edge, comminuting the glass thereof into relatively small fragments but breaking the plastic liner into relatively larger fragments; and
a size-based separator for performing a size-based separation of said glass and plastic fragments, and
wherein the thickness of the laminated glass member is sensed, and the speed of the motors driving the infeed rollers is controlled responsive thereto.

13. The device of claim 12, wherein said impactors each include:
a stanchion attached to said rotating impactor shaft;
a link pivotally attached to said stanchion; and
a hammer pivotally attached to said link.

14. The device of claim 13, wherein said links and hammers are each formed of a hardened abrasion resistant steel.

15. The device of claim 12, wherein said impactor shaft is mounted for rotation in bearings carried by means permitting convenient adjustment of the relative spacing of distal ends of said impactors from said breaker bar.

16. The device of claim 12, wherein the thickness of the laminated glass member is sensed by monitoring the speed of or the current drawn by the motor driving the impactor shaft.

17. The device of claim 12, wherein the breaker bar comprises a breaker bar support beam and a plurality of breaker bar edge members assembled thereto, said breaker bar edge members being symmetrical so as to be assembled to said breaker bar support beam in a plurality of orientations, whereby as said breaker bar edge members wear in use, the assembly can be removed and the breaker bar edge members removed and reassembled to the breaker bar support beam in differing orientations than previously, so as to present fresh cutting edges.
